(19) United States
(12) Patent Application Publication
(10) Pub. No.: US 2012/0292061 A1
(43) Pub. Date: Nov. 22, 2012

(54) FASTENER-SETTING TOOL AND METHOD FOR OPERATING A FASTENER-SETTING TOOL

(75) Inventors: Tilo DITTRICH, Feldkirch (AT); Rolf ERHARDT, Buchs (CH); Iwan WOLF, Untervaz (CH)

(73) Assignee: Hilti Aktiengesellschaft, Schaan (LI)

(21) Appl. No.: 13/473,874

(22) Filed: May 17, 2012

(30) Foreign Application Priority Data
May 19, 2011 (DE) 10 2011 076086.5

(51) Int. Cl. B25C 1/08

(52) U.S. Cl. 173/1; 227/9

(57) ABSTRACT

The invention relates to a fastener-setting tool with a combustion chamber (12), in which an electrically driven device (14) for generating turbulence or for flushing the combustion chamber (12) is arranged, and with an electrical energy storage device (24).

In order to further simplify the operation of a fastener-setting tool, the electrical energy storage device (24) is configured for operation with non-rechargeable primary cells.

### TECHNICAL FIELD

The invention relates to a fastener-setting tool having a combustion chamber, in which an electrically driven device for generating turbulence or for flushing the combustion chamber is arranged, and having an electrical energy storage device. The invention further relates to a method for operating such a fastener-setting tool.

### PRIOR ART

A fastener-setting tool with a first chamber, in which a motor-driven fan is arranged, is known from U.S. Pat. No. 7,520,252 B2.

### PRESENTATION OF THE INVENTION

The problem of the invention is to further simplify the operation of a fastener-setting tool according to the preamble of Claim 1.

The problem is solved for a fastener-setting tool with a combustion chamber, in which an electrically driven device for generating turbulence or for flushing the combustion chamber is arranged, and with an electrical energy storage device, by configuring the electrical energy storage device for an operation with non-rechargeable primary cells. The fastener-setting tool according to the invention is preferably a portable bolt-setting tool operated by combustion power. In order to set a fastening element, gas from a gas cartridge, for example, is mixed with oxygen or air in the combustion chamber to form an ignitable mixture. When the ignitable mixture is ignited, it abruptly expands to drive a working piston. Conventional fastener-setting tools are operated with batteries containing rechargeable secondary cells. The battery must be charged during operation of the fastener-setting tool, which may involve annoying interruptions. The invention allows operation of the fastener-setting tool with non-rechargeable primary cells, which can simply be replaced when necessary, without incurring long recharging times.

A preferred embodiment of the invention is characterized in that the electrical energy storage device is configured for operation with non-rechargeable, replaceable primary cells. The non-rechargeable primary cells can be quickly and easily replaced according to another aspect of the invention. For example, the non-rechargeable primary cells can be housed in an easily accessible battery compartment that can be quickly and easily opened and closed again.

Another preferred embodiment of the invention is characterized in that the electrical energy storage device is configured for operation with non-rechargeable, replaceable primary cells and/or with rechargeable secondary cells. According to another aspect of the invention two different types of battery cells can be used. This provides the advantage that the fastener-setting tool can first be operated with a battery that contains rechargeable secondary cells. When the battery is fully discharged, it can be recharged. During the recharging, the fastener-setting tool can advantageously be operated with the non-rechargeable primary cells. The fastener-setting tool according to the invention can comprise a battery cell compartment that is suitable for housing primary cells as well as for housing secondary cells. However, the fastener-setting tool can also have different battery compartments, one of which is suitable for housing primary cells and another of which is suitable for housing secondary cells.

Another preferred embodiment of the fastener-setting tool is characterized in that the fastener-setting tool comprises an identification device for recognizing primary cells or secondary cells. The identification device simplifies operation of a fastener-setting tool, especially if it contains only one housing for different batteries. After the batteries have been inserted, the type of cells involved is recognized internally.

Another preferred embodiment of the fastener-setting tool is characterized in that the identification device comprises a measurement device for measuring an internal resistance of primary and/or secondary cells. The type of battery involved is recognized internally depending on the magnitude of the internal resistance of the battery cells, for example based on stored comparative values.

Another preferred embodiment of the fastener-setting tool is characterized in that the identification device is connected to and/or combined with an electronic control device that drives an electric motor which powers the device for generating turbulence or flushing the combustion chamber. According to another aspect of the invention, the electric motor is driven differently by the electronic control device depending on whether the electrical energy storage device contains primary cells or secondary cells.

Another preferred embodiment of the fastener-setting tool is characterized in that the device for generating turbulence or for flushing the combustion chamber comprises at least one fan. The fan is driven by the electric motor. The electrical energy required for driving the electric motor is provided by the electrical energy storage device.

In a method for operating a fastener-setting tool described above, the above-specified problem is alternatively or additionally solved by detecting internally before operation of the fastener-setting tool whether the electrical energy storage device comprises non-rechargeable primary cells and/or rechargeable secondary cells. Thereby undesired disruptions in the operation of the fastener-setting tool, for example by using incorrect batteries, can be avoided. According to another aspect of the invention, it is also detected with the identification device whether a shared battery compartment suitable for accommodating both primary cells and secondary cells contains only primary cells or only secondary cells. According to another aspect of the invention, the fastener-setting tool can also be suitable for using primary cells and secondary cells simultaneously.

A preferred embodiment of the method is characterized in that various undervoltage cutoff voltages, at which the fastener-setting tool is switched off, are used depending on the type of energy storage cells used in the fastener-setting tool. This allows a stable operation of the fastener-setting tool in an easy manner over the service life of the battery cells in use, which battery cells can also be referred to as energy storage cells.

Another preferred embodiment of the method is characterized in that a charge status display device in the fastener-setting tool is switched differently depending on the type of energy storage cells inserted or used in the fastener-setting tool. According to another aspect of the invention, the remaining length of time that the fastener-setting tool can be used with the battery cells currently in use is displayed both when primary cells are used and when secondary cells are used.

Other advantages, features, and details of the invention can be deduced from the following description, in which various embodiments are described in detail with reference to the drawing.

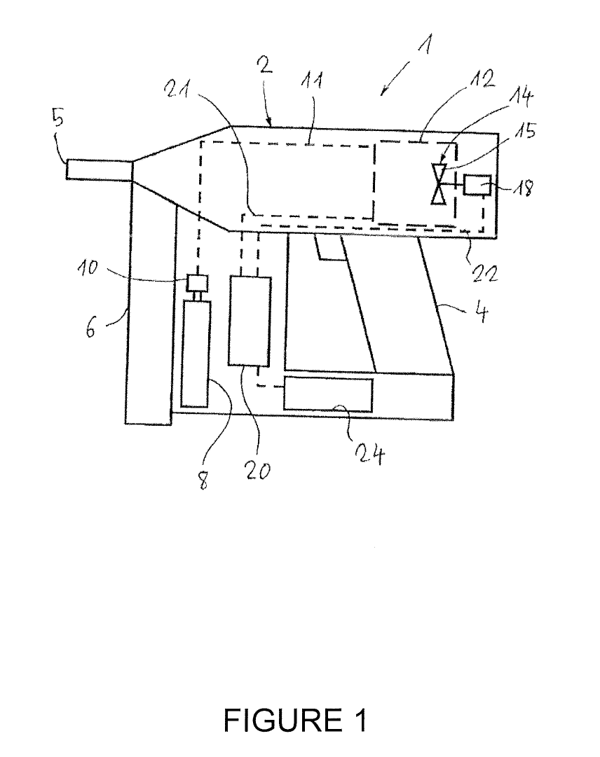

FIG. 1 shows a schematic representation of a fastener-setting tool according to the invention.

### EMBODIMENTS

FIG. 1 shows a very simplified view of a fastener-setting tool 1 with a housing 2. The housing 2 comprises a handle 4 with which the fastener-setting tool 1 can be held for driving a fastening element that exits from the fastener-setting tool 1 at a fastener-setting end 5 and can be driven into a foundation.

The fastening elements used are preferably provided by an internal magazine 6 that is mounted in the vicinity of the fastener-setting end 5 of the fastener-setting tool 1. The fastening elements are preferably removed automatically from the magazine 6 and provided at the fastener-setting end 5.

Energy required for driving the fastening elements into the foundation is provided in a gas canister or gas cartridge 8 in the interior of the fastener-setting tool 1. The gas cartridge 8 can be housed in a gas canister compartment and connected via an adjustable or controllable metering valve 10 and a gas line 11 to the combustion chamber or combustion space 12.

Gas from the gas cartridge 8 is mixed in the combustion space 12 with air to form a combustible mixture that is ignited in order to drive a fastening element such as a bolt or a nail into the foundation. The energy required for driving is transmitted from the combustion space 12 to a fastening element at the fastener-setting end 5 by a working piston (not shown), for example.

A device 14 used to generate turbulence in the combustion space 12, to flush and/or to cool the combustion space 12 is arranged in the combustion space 12. The device 14 comprises a fan 15 driven by an electric motor 18. The electric motor 18 is driven by an electronic control device 20.

An ignition cable 21 runs from the electronic control device 20 to the combustion space 12. The combustible mixture in the combustion space 12 is ignited via the ignition cable 21.

The electric motor 18 is likewise connected to the electronic control device 20 via a motor control line 22. An electrical energy storage device 24 from which the electric motor 18 obtains its drive energy is additionally connected to the control device 20.

According to an essential aspect of the invention, the electrical energy storage device 24 can comprise non-rechargeable primary cells. The non-rechargeable primary cells can preferably be exchanged in an easy manner.

The electrical energy storage device 24 comprises, for example, a battery compartment that can be closed by a battery compartment cover. The battery compartment cover can be easily opened or removed in order to insert battery cells.

In one embodiment, not shown, the battery compartment, together with the gas canister compartment, forms a supply compartment with a supply compartment cover, into which compartment the gas canister and the battery cells can be inserted. The battery cells and the gas canister are preferably permanently connected to one another and form an energy supply device with which the fastener-setting tool is driven when the energy supply device is inserted into the supply compartment.

According to another aspect of the invention, the electrical energy storage device 24 can also comprise rechargeable secondary cells. For this purpose, the control device 20 is equipped with an identification device that is used to recognize whether primary cells or secondary cells are inserted into the battery compartment. The electric motor 20 is driven differently via the control device 18 depending on the battery cells inserted into the battery compartment.

1. A fastener setting tool comprising a combustion chamber, in which an electrically driven device for generating turbulence or for flushing the combustion chamber is arranged, and, an electrical energy storage device, wherein the electrical energy storage device is configured for operation with non-rechargeable primary cells.

2. The fastener setting tool according to claim 1, wherein the electrical energy storage device is configured for operation with non-rechargeable, replaceable primary cells.

3. The fastener setting tool according to claim 1, wherein the electrical energy storage device is configured for operation with non-rechargeable primary cells and with rechargeable secondary cells.

4. The fastener setting tool according to claim 3, wherein the fastener-setting tool comprises an identification device for recognizing primary cells or secondary cells.

5. The fastener setting tool according to claim 4, wherein the identification device comprises a measurement device for measuring an internal resistance of primary and/or secondary cells.

6. The fastener setting tool according to claim 4, wherein the identification device is connected to and/or combined with an electronic control device that drives an electric motor which powers the device for generating turbulence or for flushing the combustion chamber.

7. The fastener setting tool according to claim 1, wherein the device for generating turbulence or for flushing the combustion chamber comprises at least one fan.

8. A method for operating the fastener-setting tool according to claim 3, comprising detecting internally whether the electrical energy storage device comprises non-rechargeable primary cells and/or rechargeable secondary cells before operation of the fastener-setting tool.

9. The method according to claim 8, wherein different undervoltage cutoff voltages, at which the fastener-setting tool is switched off, are used depending on the type of energy storage cells used in the fastener-setting tool.

10. The method according to claim 8, wherein a charge status display device in the fastener-setting tool is switched differently depending on the type of energy storage cells inserted or used in the fastener-setting tool.

11. The fastener-setting tool according to claim 5, wherein the identification device is connected to and/or combined with an electronic control device that drives an electric motor which powers the device for generating turbulence or for flushing the combustion chamber.

12. he fastener-setting tool according to claim 2, wherein the electrical energy storage device is configured for operation with non-rechargeable primary cells and with rechargeable secondary cells.

13. The fastener-setting tool according to claim 1, comprising an identification device for recognizing primary cells.

14. The fastener-setting tool according to claim 13, wherein the identification device comprises a measurement device for measuring an internal resistance of primary cells.

15. The fastener-setting tool according to claim 2, wherein the device for generating turbulence or for flushing the combustion chamber comprises at least one fan.

16. The fastener-setting tool according to claim 3, wherein the device for generating turbulence or for flushing the combustion chamber comprises at least one fan.

17. The fastener-setting tool according to claim 4, wherein the device for generating turbulence or for flushing the combustion chamber comprises at least one fan.

18. The fastener-setting tool according to claim 5, wherein the device for generating turbulence or for flushing the combustion chamber comprises at least one fan.

19. The fastener-setting tool according to claim 6, wherein the device for generating turbulence or for flushing the combustion chamber comprises at least one fan.

20. A method for operating the fastener-setting tool according to claim 1, comprising detecting internally whether the electrical energy storage device comprises non-rechargeable primary cells before operation of the fastener-setting tool.
